(19) United States
(12) Patent Application Publication
(10) Pub. No.: US 2022/0351094 A1
(43) Pub. Date: Nov. 3, 2022

(54) Information Processing System, and Information Processing Program

(71) Applicant: Hitachi, Ltd., Chiyoda-ku, Tokyo (JP)

(72) Inventors: Masaki HAMAMOTO, Tokyo (JP); Masashi EGI, Tokyo (JP); Daisuke TASHIRO, Tokyo (JP); Naofumi HAMA, Tokyo (JP)

(21) Appl. No.: 17/761,306

(22) PCT Filed: Jan. 22, 2021
(86) PCT No.: PCT/JP2021/002282

§ 371 Date: Mar. 17, 2022

(30) Foreign Application Priority Data
Mar. 25, 2020 (JP) 2020-053667

(51) Int. Cl. G06Q 10/04; G06K 9/62

(52) U.S. Cl. CPC G06Q 10/04; G06K 9/6256

(57) ABSTRACT

Fairness of automated assessments of AI has become a significant issue in recent years, and techniques for adjusting assessment results are being sought. This information processing system is configured to include: a first predicting unit which outputs an assessed value from input information that does not include sensitive attribute information a user has decided is not to be input; a second predicting unit which has been trained in advance, using teacher data, to estimate the sensitive attribute information that the user has decided is not to be input, and which estimates the sensitive attribute information from the input information that does not include the sensitive attribute information; and a first quantizing unit which, on the basis of the estimated value of the sensitive attribute information obtained from the second predicting unit, adjusts the assessed value output by the first predicting unit, and outputs an assessment result.

### TECHNICAL FIELD

The present invention relates to an information processing system and an information processing program that output a fair prediction result or determination result.

### BACKGROUND ART

A technology of mechanical training or artificial intelligence (hereinafter, referred to as AI) for outputting a prediction or determination result by training a complicated pattern from the past performance data has characteristics of faithfully training a determination result including the human prejudice or the unfair past convention. Therefore, in recent years, for example, AI for automatically determining whether or not to hire has serious problems of performing unfair or discriminatory determination such as applying a higher score to males than females or having a greatly different sexual adoption rate. The AI for performing such unfair or discriminatory prediction or determination is referred to as biased AI. Regarding such problems, for example, there is means for avoiding discrimination by not including sensitive information such as gender and race in input information with respect to the AI. However, for example, in the AI, an intermediate feature amount corresponding to the gender may be automatically generated from the input information such as a body height and an income, and thus, the biased AI can be created, which is not a substantial solution.

On the other hand, in the related art, there is a technology of controlling a threshold value of AI determination such that a statistical value of a determination result of AI is a desired value, in the AI which does not include the sensitive information in the input information described above but is biased (Non-Patent Document 1). In Non-Patent Document 1, for example, in AI application for determining a finance loan, AI that tends not to provide a loan to females is biased by decreasing a threshold value for determining the finance loan for females such that the finance loan is likely to be provided, and thus, a statistical value of an AI determination result relevant to a finance loan ratio of males and females is controlled to be a desired value.

### CITATION LIST

### Non-Patent Document

Non-Patent Document 1: Moritz Hardt et al., “Equality of Opportunity in Supervised Learning”, 29th Conference on Neural Information Processing Systems (NIPS 2016), December 2016, Pages 3315-3323.

### SUMMARY OF THE INVENTION

### Problems to be Solved by the Invention

In Non-Patent Document 1, an assessment threshold value of the AI is controlled on the basis of sensitive individual information of a user, and the determination result is adjusted. That is, in a system according to Non-Patent Document 1, the user is required to input the sensitive individual information to the system.

When providing a service utilizing the AI, requiring the user to input the sensitive individual information leads to an increase in the anxiousness of the user with respect to service use since how the input information is actually used is not clear for the user. In addition, even in a case where the sensitive individual information of the user continuously remains in the service system, anxiousness with respect to the misuse or leakage of the individual information remains, and thus, a psychological burden of the user on the use increases.

An object of the present invention is to attain an AI system that outputs a fair assessment result without requiring a service user to input sensitive individual information.

### Solutions to Problems

In a preferred example of an information processing system of the present invention, the information processing system is configured by including a first predicting unit which outputs an assessed value from input information not including sensitive attribute information that a user has decided not to input, a second predicting unit which has been trained in advance using teacher data to estimate the sensitive attribute information that the user has decided not to input, and estimates the sensitive attribute information from the input information not including the sensitive attribute information, and a first quantizing unit which, on the basis of an estimated value of the sensitive attribute information obtained from the second predicting unit, adjusts the assessed value output by the first predicting unit, and outputs an assessment result.

In addition, in a preferred example of an information processing program of the present invention, the information processing program is configured by allowing a computer to function as a first predicting section which outputs an assessed value from input information not including sensitive attribute information that a user has decided not to input, a second predicting section which has been trained in advance using teacher data to estimate the sensitive attribute information that the user has decided not to input, and estimates the sensitive attribute information from the input information not including the sensitive attribute information, a third predicting section which inputs the input information not including the sensitive attribute information and the estimated value of the sensitive attribute information output by the second predicting section, and outputs a reference assessed value that has predicted the assessed value output by the first predicting section, a reference predicting analyzing section which inputs the input information not including the sensitive attribute information and the estimated value of the sensitive attribute information output by the second predicting section, and outputs contribution degree information of each input feature amount with respect to the reference assessed value of the third predicting section, an attribute influence adjusting section which inputs the assessed value output by the first predicting section, the reference assessed value output by the third predicting section, the contribution degree information of each of the input feature amounts output by the reference predicting analyzing section, and threshold value information, and outputs an adjusted assessed value adjusted to remove an influence of the sensitive attribute information from the assessed value when a distance between the assessed value and the reference assessed value is less than a distance threshold value, and a second quantizing section which calculates a fourth threshold value on the basis of the estimated value of the sensitive attribute information, a first threshold value for adjusting an assessed value with respect to preferential attribute, a second threshold value for adjusting an assessed value with respect to non-preferential attribute, and information relevant to a degree of the sensitive attribute information included in the adjusted assessed value output by the attribute influence adjusting section, and adjusts the adjusted assessed value output by the attribute influence adjusting section and outputs an assessment result on the basis of the fourth threshold value.

### Effects of the Invention

According to the present invention, since it is not necessary for a service user to input sensitive individual information to a system, a psychological burden of the user on service use can be reduced. In addition, in an information processing system and an information processing program according to the present invention, since it is not necessary to input the sensitive individual information, even in a case where individual information is leaked, the damage of the user can be reduced from the viewpoint of security.

### BRIEF DESCRIPTION OF THE DRAWINGS

FIG. 1 is a diagram illustrating a configuration example of an information processing system 10 of Example 1.

FIG. 2 is a diagram illustrating an example of an adjusting section of a quantizing unit 130.

FIG. 3 is a diagram illustrating a display example of a user screen 300.

FIG. 4 is a diagram illustrating a configuration example of an information processing system 20 of Example 2.

FIG. 5 is a diagram illustrating an example of a creating section of a reference predictor 210.

FIG. 6 is a diagram illustrating a configuration example of a reference predicting analyzing unit 220.

FIG. 7 is a diagram illustrating the concept of an adjusting section of an attribute influence adjusting unit 260.

FIG. 8 is a flowchart illustrating an example of the adjusting section of the attribute influence adjusting unit 260.

FIG. 9 is a diagram illustrating an example of an adjusting section of a quantizing unit 230.

FIG. 10 is a diagram illustrating a display example of a user screen 1000.

### MODE FOR CARRYING OUT THE INVENTION

Hereinafter, Examples will be described with reference to the diagrams. The same reference numerals will be applied to the same constituents, and the repeated description thereof will be omitted.

Here, Examples will be described with an information processing system using label prediction type AI for assessing whether or not to provide a finance loan as an example. In this information processing system, in a case where an assessment result of the finance loan with respect to a user is set to Y, the finance loan is available (that is, a result that is preferable for the user) when Y=1, and the finance loan is not available (that is, a result that is not preferable for the user) when Y=0.

In addition, in a case where sensitive attribute information (attribute information that may particularly lead to discrimination in individual information, attribute information including performance of being discriminated in the past (in history)) of the user is set to Sᵢ, Sᵢ=0 indicates that the user belongs to a societally preferential group (also referred to as preferential attribute), and Sᵢ=1 indicates that the user belongs to a societally non-preferential group (also referred to as non-preferential attribute), for example, the user was a target for discrimination in the past. For example, in a case where the sensitive attribute information is “gender” S₁, S₁=1 corresponds to females, and S₁=0 corresponds to males. For example, in a case where the sensitive attribute information is “race (the color of the skin)” S₂, S₂=1 corresponds to black people, and S₂=0 corresponds to white people.

### Example 1

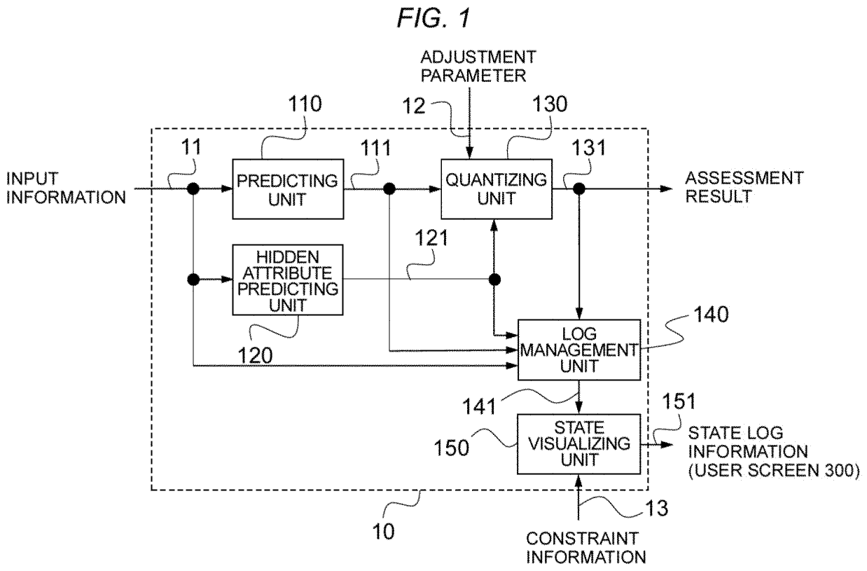

FIG. 1 illustrates a configuration example of an information processing system 10 according to Example 1. The information processing system 10 includes each function unit of a predicting unit 110, a hidden attribute predicting unit 120, a quantizing unit 130, a log management unit 140, and a state visualizing unit 150.

In addition, an adjustment parameter and a constraint condition are set in advance and stored in a storing unit (not illustrated). When executing the information processing system 10, the adjustment parameter and the constraint condition are used by being suitably read out from the storing unit.

The information processing system 10 can be configured on a general-purpose calculator, and a hardware configuration thereof is not illustrated, but each of the function units is attained by loading a program stored in the storing unit to a RAM and by executing the program with a CPU.

The predicting unit 110 is a processing unit of AI that outputs a label predicted value (that is, assessed value information 111) on the basis of input information 11. The input information 11 is the individual information of the user that is used in the finance loan assessment, but does not include the sensitive attribute information Sᵢ (when operating the information processing system 10, sensitive attribute information listed in advance as individual information that does not require the user to which a service is provided to input). The predicting unit 110, for example, is a predictor using deep learning, and in this Example, an output value thereof (that is, an assessed value y) is a continuous value of “0” to “1” normalized by a sigmoid function.

The hidden attribute predicting unit 120 is a processing unit that outputs an estimated value sᵢ′ of the sensitive attribute information Sᵢ of the user (that is, estimated sensitive attribute information 121) on the basis of the input information 11. The hidden attribute predicting unit 120, for example, is a predictor using deep learning, and can be created by using training data with a feature amount identical to an input feature amount of the predicting unit 110 as input, and the corresponding sensitive attribute information Sᵢ (the sensitive attribute information listed in advance as the individual information that does not require the user to which the service is provided to input) as an answer. Here, it is not necessary that training data that is applied to the learning is identical to the training data used for creating the predicting unit 110.

In a case where there are a plurality of sensitive attribute information items Sᵢ, the hidden attribute predicting unit 120 includes a “hidden attribute predicting unit 1 predicting s₁′”, a “hidden attribute predicting unit 2 predicting s₂′”, and the like.

In this Example, the estimated value sᵢ′ of the sensitive attribute information Sᵢ is a continuous value of “0” to “1” normalized by a sigmoid function. As described above, in Non-Patent Document 1, a true value that requires the user to input is give as the sensitive attribute information, and thus, the value is a discrete value of “0” or “1”, whereas the sensitive attribute information in this Example is given by the estimated value sᵢ′, and thus, it is necessary to treat the continuous value indicating the degree of confidence for estimating the sensitive attribute information, which is one of major differences between Patent Document 1 and this Example.

The quantizing unit 130 is a processing unit that calculates the assessment result by quantizing the assessed value y of the assessed value information 111, and outputs the assessment result as assessment result information 131, on the basis of the estimated sensitive attribute information 121 and adjustment parameter information 12.

The adjustment parameter information 12 is information relevant to a threshold value for quantizing the assessed value y, and in this Example, includes information of a standard assessment threshold value Th_{Y}, an assessment threshold value αₚ of the preferential attribute, and an assessment threshold value αₙₚ of the non-preferential attribute. The standard assessment threshold value Th_{Y} is a threshold value that is used for quantizing the assessed value y when fairness is not considered, and is generally a value close to 0.5. The standard assessment threshold value Th_{Y} is obtained by a procedure of training the predictor of the predicting unit 110. The assessment threshold value αₚ of the preferential attribute is a threshold value that is used for quantizing the assessed value y of the preferential attribute group, and as a guide, is a value of Th_{Y}≤αₚ<1. The assessment threshold value αₙₚ of the non-preferential attribute is a threshold value that is used for quantizing the assessed value y of the non-preferential attribute group, and as a guide, is a value of 0<αₙₚ≤Th_{Y}. Examples of a method for calculating an optimum value of the assessment threshold value αₚ of the preferential attribute and the assessment threshold value αₙₚ of the non-preferential attribute include Non-Patent Document 1 and the like.

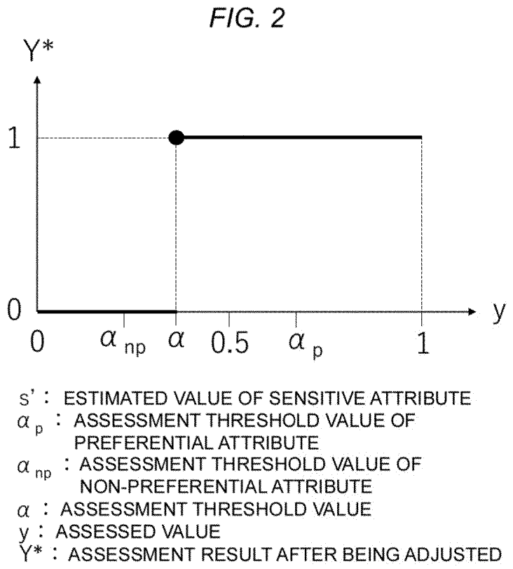

FIG. 2 illustrates a specific example of an adjusting section of the quantizing unit 130. In quantizing processing of the assessed value y according to this Example, when the assessed value y is greater than or equal to the assessment threshold value α, an assessment result Y* after being adjusted is “1”, and when the assessed value y is less than the assessment threshold value α, the assessment result Y* after being adjusted is “0”. Here, the assessment threshold value α can be obtained by Expression (1).

[Expression 1]

α=αₚ×(1−s′)+αₙₚ×s′ (1)

Here, αₚ and αₙₚ are the assessment threshold values of the preferential attribute and the non-preferential attribute, respectively. s′ is the estimated value of the sensitive attribute information. Note that, in this Example, a calculation example of the assessment threshold value α in a case where Sensitive Attribute Information S=0 is the preferential attribute, and the possibility of the non-preferential attribute increases as the value of the estimated value s′ of the sensitive attribute information increases is described. As described above, the assessment threshold value α is set such that a result that is preferable for the user of the non-preferential attribute is easily obtained, and thus, AI that performs unfair prediction can be biased to suppress the unfair prediction, and a fairer information processing system can be provided.

Note that, in a case where there are a plurality of estimated values (s₁′, s₂′, . . . ) of the sensitive attribute information, the assessment threshold value α can be obtained as a linear sum represented in Expression (2). Here, the assessment threshold value α is clipped to be 0≤α≤1.

[Expression 2]

α=αₚ₁×(1−s₁′)+αₙₚ₁×s₁′+αₚ₂×(1−s₂′)+αₙₚ₂×s₂′+ (2)

Here, αₚ₁ and αₚ₂, and αₙₚ₁ and αₙₚ₂ are the assessment threshold values of the preferential attribute and the non-preferential attribute, respectively.

The log management unit 140 is a storage processing unit that stores state information relevant to a processing procedure that is performed until the information processing system 10 derives the assessment result information 131 from the input information 11 in a non-volatile storage device such as a hard disk or a volatile storage device such as a dynamic random access memory (DRAM). The state information that is stored includes the input information 11, the assessed value information 111, the estimated sensitive attribute information 121, and the assessment result information 131, and for example, is used for visualizing internal state information of the system to an owner of the information processing system according to this Example, such as a financial institute.

The state visualizing unit 150 reads out state log information 141 from the log management unit 140 to be output as state log information 151 to a user screen 300 of the system owner by further using constraint information 13. The constraint information 13 includes the attribute threshold value Thₛ for quantizing the estimated value sᵢ′ of the sensitive attribute information, and information of a target value, an upper limit value, and a lower limit value of a fairness index value F.

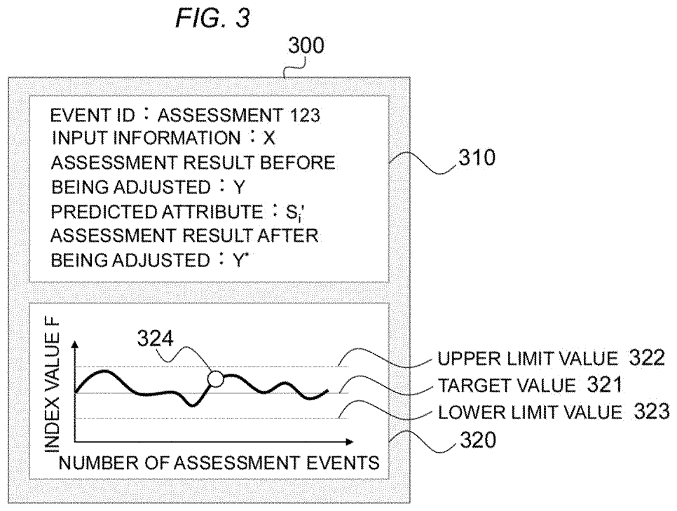

FIG. 3 illustrates an example of the user screen 300 according to this Example. The user screen 300 includes a region 310 for displaying the internal state information, and a region 320 for displaying the state of the fairness index value.

In the region 310 for displaying the internal state information, for example, an event ID that is an identifier of a finance loan assessment event in a financial institute, and input information X, an assessment result Y before being adjusted, predicted attribute Sᵢ′, and an assessment result Y* after being adjusted in the finance loan assessment event are displayed. The input information X is the input information 11. The assessment result Y before being adjusted is obtained by using the assessment threshold value Th_{Y} to be “1” in a case where the assessed value y is greater than or equal to the assessment threshold value Th_{Y} (that is, finance loan approval), and to be “0” in a case where the assessed value y is less than the assessment threshold value Th_{Y} (that is, finance loan disapproval). The predicted attribute S′ is obtained by using the attribute threshold value Thₛ to be “1” in a case where the estimated value sᵢ′ of the sensitive attribute information is greater than or equal to the attribute threshold value Thₛ (that is, the non-preferential attribute), and to be “0” in a case where the estimated value sᵢ′ is less than the attribute threshold value Thₛ (that is, the preferential attribute). The assessment result Y* after being adjusted is the assessment result information 131.

In the region 320 for displaying the state of the fairness index value, a target value 321, an upper limit value 322, and a lower limit value 323 of the fairness index value F, and the transition of an estimated value of the fairness index value F with respect to the finance loan assessment event are displayed. An example of the fairness index value F includes an index value of group fairness, and a ratio of a probability {P[Y=1|S=1]} of obtaining the finance loan approval assessment (Y=1) in the non-preferential attribute (S=1) group to a probability {P[Y=1|S=0]} of obtaining the finance loan approval assessment (Y=1) in the preferential attribute (S=0) group can be obtained as represented in Expression (3).

$$\begin{matrix}[ Expression 3 ] & \\ F = \frac{P [ Y = 1 \vert S = 1 ]}{P [ Y = 1 \vert S = 0 ]} & ( 3 )\end{matrix}$$

For example, in a case where the sensitive attribute information is the “gender” S, as the transition of the ratio of a probability that the person who performs the finance loan approval assessment is male and a probability that the person who performs the finance loan approval assessment is female, the transition of the fairness index value F is displayed from the past log stored in the log management unit 140. The internal state information of the past event ID that is represented by a white circle 324 is displayed in the region 310.

In this case, the target value 321 is generally set to F=1. The upper limit value 322 and the lower limit value 323 depend on the culture or the law of each country, but the upper limit value 322 is a value such as 1.2, and the lower limit value 323 is a value such as 0.8, on the basis of a fluctuation range of approximately 20%. It is considered that the owner of the information processing system 10 (for example, a bank) suitably sets the constraint information 13, monitors the transition of the fairness index value F, and performs the maintenance of the system in a case where the transition is greater than the upper limit value or the lower limit value.

The above description is Example of the information processing system 10. According to Example, it is possible to attain a fair assessment result without requiring the sensitive individual information of the service user, and it is possible to reduce a psychological burden of the user on the service use. In addition, in the information processing system according to this Example, it is not necessary to input the sensitive individual information, and thus, it is possible to reduce a risk relevant to privacy for the sensitive individual information from the viewpoint of the system owner.

### Example 2

In the information processing system 10 described in Example 1, the service user of the non-preferential attribute is easily obtain uniformly preferred assessment results without considering the substantial influence of the sensitive attribute information on the assessment result of the AI. In Example 2, an information processing system 20 that performs adjustment to obtain an assessment result from which the influence of the sensitive attribute information is removed is described. Accordingly, it is possible to attain a fair information processing system that derives an assessment result from which the substantial influence of the sensitive attribute information on the assessment result of the AI is removed.

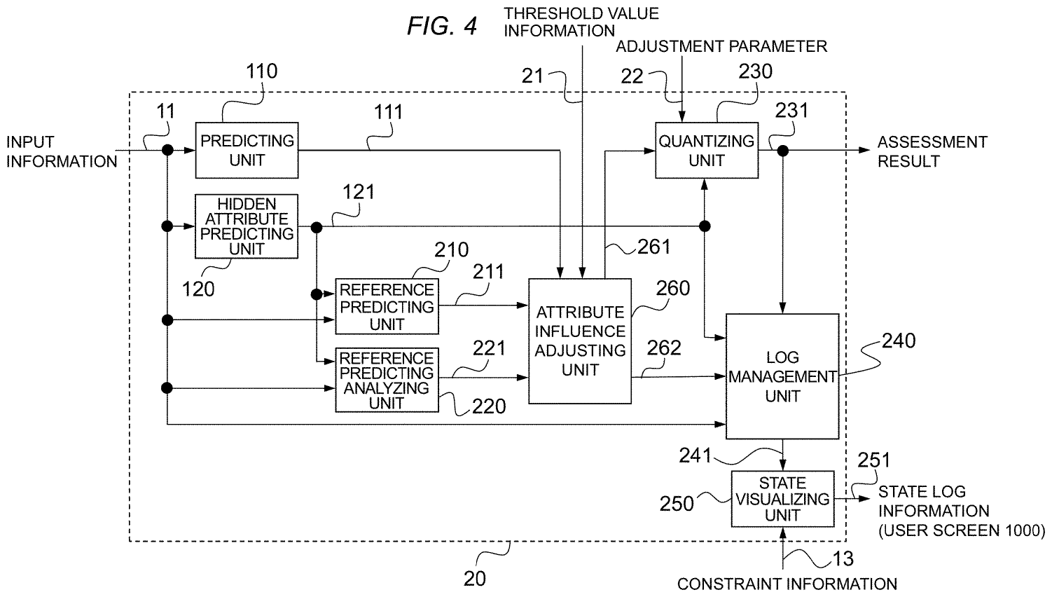

FIG. 4 illustrates a configuration example of the information processing system 20 according to this Example. The information processing system 20 includes each function unit of the predicting unit 110, the hidden attribute predicting unit 120, a reference predicting unit 210, a reference predicting analyzing unit 220, an attribute influence adjusting unit 260, a quantizing unit 230, a log management unit 240, and a state visualizing unit 250.

In addition, threshold value information, an adjustment parameter, and a constraint condition are set in advance and stored in a storing unit (not illustrated). When executing the information processing system 20, the threshold value information, the adjustment parameter, and the constraint condition are used by being suitably read out from the storing unit.

The reference predicting unit 210 is a prediction processing unit that simulates the behavior of the predicting unit 110, and outputs a reference assessed value y′ that has predicted the assessed value y of the predicting unit 110 by using the input information 11 and the estimated sensitive attribute information 121 as reference assessed value information 211.

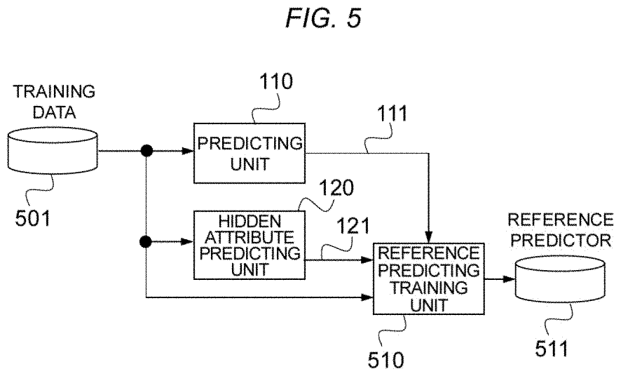

FIG. 5 illustrates an example of a creating section of a predictor (here, referred to as a reference predictor 511) that is applied to the reference predicting unit 210. The reference predictor 511 is a predictor that is attained by deep learning or the like, and is a prediction model for estimating the assessed value of the predicting unit 110 by using the input information 11 and the estimated sensitive attribute information 121 as input. In order to create the reference predictor 511, the reference predicting training unit 510 performs supervised learning by using training data 501 and the estimated sensitive attribute information 121 predicted by the hidden attribute predicting unit 120 from the training data 501 as an input feature amount, and the assessed value information 111 of the predicting unit 110 assessed by using the training data 501 as the input feature amount as an answer. Accordingly, it is possible to obtain the reference predictor 511 that is applied to the reference predicting unit 210.

The reference predicting analyzing unit 220 is a processing unit that analyzes the authority of the reference assessed value y′ output by the reference predicting unit 210, and outputs contribution degree information 221 of each of the input feature amounts with respect to an output value of the reference predicting unit 210 (that is, the reference assessed value y′) by using the input information 11 and the estimated sensitive attribute information 121 as input.

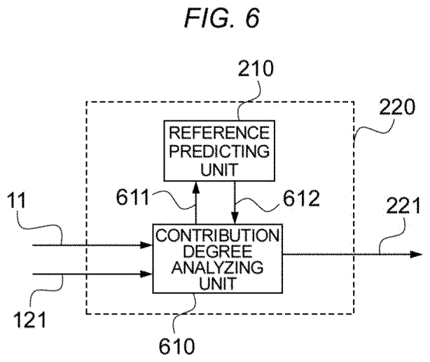

FIG. 6 illustrates a configuration example of the reference predicting analyzing unit 220. The reference predicting analyzing unit 220 includes the reference predicting unit 210 and a contribution degree analyzing unit 610. The contribution degree analyzing unit 610 is a processing unit that calculates a contribution degree of each of the input feature amounts with respect to the output value of the reference predicting unit 210 to be output as the contribution degree information 221 of each of the input feature amounts. In the contribution degree of each of the feature amounts, for example, a Shapley value can be used. The contribution degree analyzing unit 610 repeats an operation of inputting a feature amount in which a perturbation is added to a center feature amount (referred to as a perturbation feature amount 611) to the reference predicting unit 210 by using the value of the input information 11 and the estimated sensitive attribute information 121 as the center feature amount, and of statistically processing an assessed value 612 that is an output value, and thus, is capable of obtaining the Shapley value (that is, the contribution degree) of each of the input feature amounts.

The attribute influence adjusting unit 260 is a processing unit that calculates the adjusted assessed value y* adjusted such that the influence of the sensitive attribute information is removed from the assessed value y of the predicting unit 110 to be output as adjusted assessed value information 261 by using the assessed value information 111, the reference assessed value information 211, the contribution degree information 221 of each of the input feature amounts, and threshold value information 21.

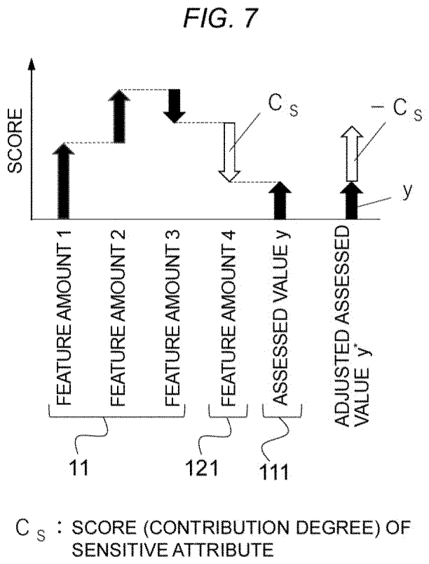

FIG. 7 illustrates the concept of an adjusting section of the attribute influence adjusting unit 260. Here, an example is illustrated in which the input information 11 includes a feature amount 1 to a feature amount 3, and the estimated sensitive attribute information 121 is expressed as a feature amount 4. The influence of each of the input feature amounts on the assessed value y is illustrated, the length of an arrow indicates the size of the contribution degree, and the direction of the arrow indicates positive and negative signs of the contribution degree. The sum of the contribution degrees of each of the input feature amounts is normalized to be coincident with the assessed value y. In the example of FIG. 7, the feature amount 1 and the feature amount 2 contribute to the assessed value y in a positive direction, which corresponds to the authority of the finance loan approval. On the other hand, the feature amount 3 and the feature amount 4 contribute to the assessed value y in a negative direction, which corresponds to the authority of the finance loan disapproval. Here, since the feature amount 4, for example, corresponds to the sensitive attribute information such as gender or nationality, it is desirable to remove the influence from the assessed value y in order to obtain a fair assessment result with respect to the sensitive attribute information. Therefore, the attribute influence adjusting unit 260 adjusts the assessed value y to cancel out a contribution degree Cₛ of the sensitive attribute information (in FIG. 7, the contribution degree of the feature amount 4), and thus, obtains the adjusted assessed value y*.

Note that, in the example of FIG. 7, the estimated sensitive attribute information 121 is expressed as the feature amount 4, but in a case where there are a plurality of sensitive attribute information items, the estimated sensitive attribute information 121 is the estimated values sᵢ′ of the plurality of sensitive attribute information items Sᵢ. In this case, the feature amount 4 is expressed by adding feature amounts of each of the estimated values sᵢ′ in the negative direction in multiple stages.

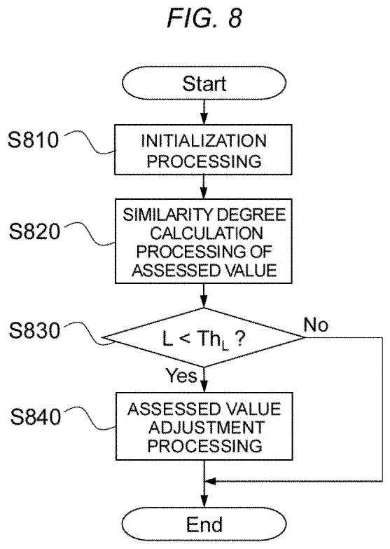

FIG. 8 illustrates a specific example of the adjusting section of the attribute influence adjusting unit 260. The appositeness of an adjusting method illustrated in FIG. 7 is affected by the validity of the contribution degree Cₛ of the sensitive attribute information. Accordingly, here, an example of adopting an algorithm in which when a similarity degree of output results (that is, the assessed value y and the reference assessed value y′) of the predicting unit 110 and the reference predicting unit 210 are set to the index of the validity, it is determined that the contribution degree Cₛ of the sensitive attribute information is validly evaluated in a case where the output results are coincident with each other, and it is determined that the contribution degree Cₛ of the sensitive attribute information is not validly evaluated in a case where the output results are greatly different from each other, and adjustment processing is not performed is described.

First, as a processing step S810, initialization processing is performed. Specifically, the assessed value y is set to the adjusted assessed value y* (that is, y*=y), and “0” is set to an attribute influence adjustment flag γ (that is, γ=0).

Next, as a processing step S820, similarity degree calculation processing of the assessed value is performed. Specifically, a distance L between the assessed value y and the reference assessed value y′ is introduced as the index of the similarity degree, and a difference absolute value between the assessed value y and the reference assessed value y′ is obtained as the distance L (that is, L=|y−y′|).

Next, as a processing step S830, with reference to the distance threshold value Th_{L}, in a case where the distance L is less than the distance threshold value Th_{L}, it is determined that the assessed value y and the reference assessed value y′ are sufficiently similar to each other, and the process proceeds to processing step S840, otherwise the adjustment processing is ended. The distance threshold value Th_{L} is a parameter that is give as the threshold value information 21.

In the processing step S840, assessed value adjustment processing is performed. Specifically a lower limit value of the adjusted assessed value y* is set to “0”, an upper limit value thereof is set to “1”, and a value obtained by subtracting the contribution degree Cₛ of the sensitive attribute information from the assed value y is set by Expression (4).

[Expression 4]

y*=max(min(y−C_{S},1),0) (4)

In addition, in the processing step S840, “1” is set to the attribute influence adjustment flag γ (that is, γ=1). Here, the lower limit value and the upper limit value of the adjusted assessed value y* are set to “0” and “1”, respectively, on the premise that in this Example, the predicting unit 110 is configured by a deep neural network, a value normalized from “0” to “1” by a sigmoid function is output as the assessed value y. The above description is the specific example of the adjusting section of the attribute influence adjusting unit 260.

The quantizing unit 230 is a processing unit that calculates the assessment result by quantizing the adjusted assessed value y* of the adjusted assessed value information 261 to be output as assessment result information 231, by using estimated sensitive attribute information 121 and an adjustment parameter 22.

The adjustment parameter information 22 is information relevant to a threshold value for quantizing the adjusted assessed value y*, and includes a threshold value adjustment factor βₚ of the preferential attribute and a threshold value adjustment factor βₙₚ of the non-preferential attribute, in addition to the standard assessment threshold value Th_{Y}, the assessment threshold value αₚ of the preferential attribute, and the assessment threshold value αₙₚ of the non-preferential attribute, which are used in the information processing system 10.

The threshold value adjustment factor βₚ of the preferential attribute is a parameter for adjusting how much a bias effect due to the assessment threshold value αₚ of the preferential attribute is removed in a case where the influence of the sensitive attribute information is removed from the assessed value y by the attribute influence adjusting unit 260, and has a value of “0” to “1” (that is, 0≤βₚ≤1). The threshold value adjustment factor βₙₚ of the non-preferential attribute is a parameter for adjusting how much a bias effect due to the assessment threshold value αₙₚ of the non-preferential attribute is removed in a case where the influence of the sensitive attribute information is removed from the assessed value y by the attribute influence adjusting unit 260, and has a value of “0” to “1” (that is, 0≤βₙₚ≤1). As described above, the threshold value adjustment factor βₚ of the preferential attribute and the threshold value adjustment factor βₙₚ of the non-preferential attribute function as a parameter for adjusting the effect of the adjusting section by adjusting the assessment threshold value α, which is used in the information processing system 10 of Example 1, and the adjusting section of the attribute influence adjusting unit 260.

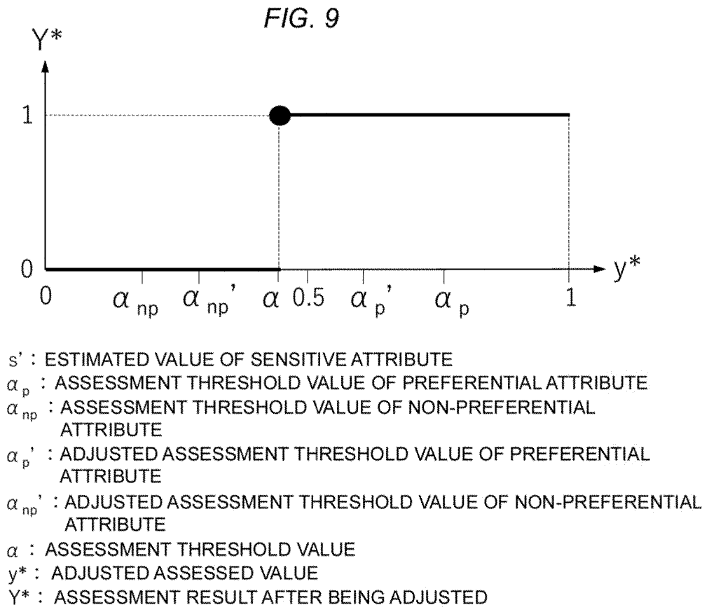

FIG. 9 illustrates a specific example of an adjusting section of the quantizing unit 230. Here, when the adjusted assessed value y* of the adjusted assessed value information 261 is greater than or equal to the assessment threshold value α, the assessment result Y* after being adjusted is “1”, and in a case where the adjusted assessed value y* is less than the assessment threshold value α, the assessment result Y* after being adjusted is “0”. Here, the assessment threshold value α can be obtained by Expression (5).

[Expression 5]

α=αₚ′×(1−s′)+αₙₚ′×s′ (5)

Here, s′ is the estimated value of the sensitive attribute information. In addition, αₚ′ and αₙₚ′ are an adjusted assessment threshold value of the preferential attribute and an adjusted assessment threshold value of the non-preferential attribute, respectively, which can be obtained by Expression (6) and Expression (7) using the standard assessment threshold value Th_{y}, the assessment threshold value αₚ of the preferential attribute, the assessment threshold value αₙₚ of the non-preferential attribute, the threshold value adjustment factor βₚ of the preferential attribute, the threshold value adjustment factor βₙₚ of the non-preferential attribute, and the attribute influence adjustment flag γ.

[Expression 6]

αₚ′=αₚ+(Th_{Y}−αₚ)×βₚ×γ (6)

[Expression 7]

αₙₚ′=αₙₚ+(Th_{Y}−αₙₚ)×βₙₚ×γ (7)

Note that, in a case where there are a plurality of estimated values (s₁′, s₂′, . . . ) of the sensitive attribute information, the assessment threshold value α represented in Expression (5) can be obtained as a linear sum represented in Expression (8). Here, the assessment threshold value α is clipped to be 0≤α≤1.

[Expression 8]

α=αₚ₁′×(1−s₁′)+αₙₚ₁′×s₁′+αₚ₂′×(1−s₂′)+αₙₚ₂′×s₂′+ (8)

In addition, an adjusted assessment threshold value αₚᵢ′ of the preferential attribute and an adjusted assessment threshold value αₙₚᵢ′ of the non-preferential attribute of the sensitive attribute information Sᵢ can be obtained by Expression (9) and Expression (10).

[Expression 9]

αₚᵢ′=αₚᵢ+(Th_{Y}−αₚᵢ)×βₚᵢ×γ (9)

[Expression 10]

αₙₚᵢ′=αₙₚᵢ+(Th_{Y}−αₙₚᵢ)×βₙₚᵢ×γ (10)

Here, αₚᵢ and αₙₚᵢ are the assessment threshold value of the preferential attribute and the non-preferential attribute of the sensitive attribute information Sᵢ, and βₚᵢ and βₙₚᵢ are the threshold value adjustment factor of the preferential attribute and the non-preferential attribute of the sensitive attribute information Sᵢ.

Here, the attribute influence adjustment flag γ is flag information indicating whether or not the adjustment processing obtained by the attribute influence adjusting unit 260 is performed, and is included in the adjusted assessed value information 261. A case where both values of the threshold value adjustment factor βₚ of the preferential attribute and the threshold value adjustment factor βₙₚ of the non-preferential attribute are indicates that the adjustment processing relevant to the sensitive attribute information is not performed in the quantizing unit 230, and thus, it is preferable that the values are set to a value close to “1” for an application in which it can be expected that the adjusted assessed value y* can be obtained by sufficiently removing the influence of the sensitive attribute information from the assessed value y. As described above, the threshold value adjustment factor βₚ of the preferential attribute and the threshold value adjustment factor βₙₚ of the non-preferential attribute can also expressed as a parameter for expressing the degree of sensitive attribute information Sᵢ included in the adjusted assessed value y*. Note that, in this Example, Sensitive Attribute Information Sᵢ=0 is set to the preferential attribute, and a calculation example of the assessment threshold value α in a case of indicating that the possibility of the non-preferential attribute increases as the value of the estimated value sᵢ′ of the sensitive attribute information increases is described.

The log management unit 240 is a storage processing unit that stores state information relevant to a processing procedure that is performed until the information processing system 20 derives the assessment result information 231 from the input information 11 in a non-volatile storage device or a volatile storage device. The state information that is stored includes the input information 11, the assessed value information 111, the estimated sensitive attribute information 121, the assessment result information 231, the contribution degree information 221 of each of the input feature amounts, the adjusted assessed value information 261, and validity information of the contribution degree Cₛ of the sensitive attribute obtained by the attribute influence adjusting unit 260 (that is, the distance L between the assessed value y and the reference assessed value y′). Here, the assessed value information 111, the contribution degree information 221 of each of the input feature amounts, adjusted assessed value information 261 and the validity information of the contribution degree Cₛ are included in internal state information 262 that is obtained from the attribute influence adjusting unit 260.

The state visualizing unit 250 reads out state log information 241 from the log management unit 240 to be output as state log information 251 to the user screen 1000 of the system owner by further using the constraint information 13.

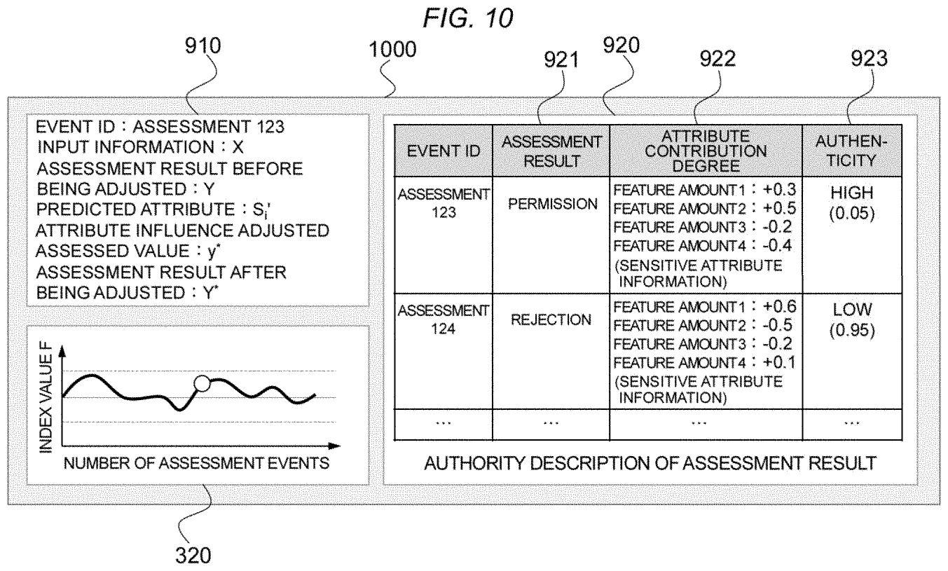

FIG. 10 illustrates an example of the user screen 1000 according to this Example. The user screen 1000 includes a region 910 for displaying the internal state information, a region 320 for displaying the state of the fairness index value, and a region 920 for displaying the authority description of the assessment result.

In the region 910 for displaying the internal state information by designating the event ID, an attribute influence adjusted assessed value that is adjusted to remove the attribute influence is displayed, in addition to the event ID, the input information, the assessment result before being adjusted, the predicted attribute, and the assessment result after being adjusted, which are displayed on the user screen 300 of the information processing system 10. The attribute influence adjusted assessed value is the adjusted assessed value included in the adjusted assessed value information 261.

In the region 920 for displaying the authority description of the assessment result, an assessment result 921 and an attribute contribution degree 922 thereof, and authenticity 923 of contribution degree analysis are displayed for each of the event IDs. The assessment result 921 is information of the assessment result Y* after being adjusted, and the assessment result of finance loan approval or disapproval is displayed. Here, the finance loan approval (that is, Y*=1) is expressed as permission, and the finance loan disapproval (that is, Y*=0) is expressed as rejection. The attribute contribution degree 922 is information of the contribution degree information 221 of each of the input feature amounts, and not only the contribution degree of the feature amount included in the input information 11 but also information of the contribution degree of the sensitive attribute information with respect to the assessed value y are displayed. Here, the feature amount 4 corresponds to the contribution degree of the sensitive attribute information. The authenticity 923 is information indicating the validity of the evaluation of the attribute contribution degree 922, and is equivalent to the validity information of the contribution degree Cₛ of the sensitive attribute information (that is, the distance L between the assessed value y and the reference assessed value y′). Here, in the authenticity 923, when the distance L is less than the distance threshold value Th_{L}, the authenticity can be simply expressed as “high”, when the distance L is greater than the distance threshold value Th_{L}, the authenticity can be simply expressed as “low”. In FIG. 10, an example of displaying both of the simplified expression and the numerical value of the distance L is illustrated.

As described above, the information processing system 20 is characterized in that not only is the attribute influence removed from the assessed value y output by the predicting unit 110, but also the degree of influence (that is, the contribution degree) of the sensitive attribute information on the assessed value y can be quantified and visualized, and thus, can be extremely effectively utilized in order to improve the fairness of the AI determination not only when operating the service but also when developing the AI.

The above description is the information processing system 20 described as a second embodiment according to the present invention. Accordingly, it is possible to attain the fair information processing system 20 considering a substantial influence of the sensitive attribute information on the assessment result of the AI.

In addition, the predicting unit 110 of the information processing system 10 and the information processing system 20 described above is not limited to the label prediction type AI for assessing whether or not to provide a finance loan, and can be applied to AI for outputting an assessment result according to the service purpose by inputting the individual information according to the user. Even in a case where the predicting unit 110 is AI of which the inside is a black box created by a third person, it is possible to configure the information processing system 10 or the information processing system 20 by introducing the AI.

### REFERENCE SIGNS LIST

10 Information processing system
11 Input information
12 Adjustment parameter
13 Constraint information
20 Information processing system
21 Threshold value information
22 Adjustment parameter
110 Predicting unit
111 Assessed value information
120 Hidden attribute predicting unit
121 Estimated sensitive attribute information
130 Quantizing unit
131 Assessment result information
140 Log management unit
141 State log information
150 State visualizing unit
151 State log information
210 Reference predicting unit
211 Reference assessed value information
220 Reference predicting analyzing unit
221 Contribution degree information of each input feature amount
230 Quantizing unit
231 Assessment result information
240 Log management unit
241 State log information
250 State visualizing unit
251 State log information
260 Attribute influence adjusting unit
261 Adjusted assessed value information
262 Internal state information
300 User screen
310 Region for displaying internal state information
320 Region for displaying state of fairness index value
321 Target value of fairness index value F
322 Upper limit value of fairness index value F
323 Lower limit value of fairness index value F
324 Past event ID for displaying internal state information
501 Training data
510 Reference predicting training unit
511 Reference predictor
610 Contribution degree analyzing unit
611 Feature amount in which perturbation is added to center feature amount (perturbation feature amount)
612 Assessed value that is output value of reference predicting unit 210
910 Region for displaying internal state information
920 Region for displaying authority description of assessment result
921 Assessment result for each event ID
922 Attribute contribution degree for each event ID (contribution degree information of each input feature amount)
923 Authenticity (information indicating validity of evaluation of attribute contribution degree 922)
1000 User screen

1. An information processing system, comprising:
a first predicting unit which outputs an assessed value from input information not including sensitive attribute information that a user has decided not to input;
a second predicting unit which has been trained in advance using teacher data to estimate the sensitive attribute information that the user has decided not to input, and estimates the sensitive attribute information from the input information not including the sensitive attribute information; and
a first quantizing unit which, on the basis of an estimated value of the sensitive attribute information obtained from the second predicting unit, adjusts the assessed value output by the first predicting unit, and outputs an assessment result.

2. The information processing system according to claim 1,
wherein the first quantizing unit
calculates a third threshold value on the basis of the estimated value of the sensitive attribute information, a first threshold value for adjusting an assessed value with respect to preferential attribute, and a second threshold value for adjusting an assessed value with respect to non-preferential attribute, and adjusts the assessed value output by the first predicting unit and outputs the assessment result on the basis of the third threshold value.

3. The information processing system according to claim 1, further comprising:
a log management unit which stores the input information, the assessed value output by the first predicting unit, the estimated value of the sensitive attribute information obtained from the second predicting unit, and the assessment result output by the first quantizing unit as state log information in a storage device, for each event that inputs the input information according to the user and outputs the assessment result; and
a state visualizing unit which reads out the state log information of the past event stored in the log management unit, and calculates a fairness index value to be output to a user screen.

4. The information processing system according to claim 3,
wherein the state visualizing unit displays a transition of an estimated value of the fairness index value with respect to the past event according to the designated sensitive attribute information from the state log information of the past event in a graph, and simultaneously outputs the state log information of an arbitrary event to the user screen.

5. The information processing system according to claim 1, further comprising:
a third predicting unit which inputs the input information not including the sensitive attribute information and the estimated value of the sensitive attribute information output by the second predicting unit, and outputs a reference assessed value that has predicted the assessed value output by the first predicting unit;
a reference predicting analyzing unit which inputs the input information not including the sensitive attribute information and the estimated value of the sensitive attribute information output by the second predicting unit, and outputs contribution degree information of each input feature amount with respect to the reference assessed value of the third predicting unit;
an attribute influence adjusting unit which inputs the assessed value output by the first predicting unit, the reference assessed value output by the third predicting unit, the contribution degree information of each of the input feature amounts output by the reference predicting analyzing unit, and threshold value information, and outputs an adjusted assessed value adjusted to remove an influence of the sensitive attribute information from the assessed value; and
a second quantizing unit which, by using the estimated value of the sensitive attribute information output from the second predicting unit, and an adjustment parameter, quantizes the adjusted assessed value output by the attribute influence adjusting unit, and outputs the assessment result, instead of the first quantizing unit.

6. The information processing system according to claim 5,
wherein the third predicting unit is configured by being trained in advance by using training data and the estimated value of the sensitive attribute information predicted by the second predicting unit from the training data as the input feature amount, and the assessed value output by the first predicting unit by using the training data as the input feature amount as an answer, and
inputs the input information not including the sensitive attribute information and the estimated value of the sensitive attribute information output by the second predicting unit, and outputs the reference assessed value that has predicted the assessed value output by the first predicting unit.

7. The information processing system according to claim 5,
wherein the reference predicting analyzing unit includes the third predicting unit and a contribution degree analyzing unit, and
the contribution degree analyzing unit repeats an operation of inputting the input information not including the sensitive attribute information and the estimated value of the sensitive attribute information output by the second predicting unit, of inputting a feature amount in which a perturbation is added to the input information and the estimated value to the third predicting unit, and of statistically processing an output value to output the contribution degree information of each of the input feature amounts.

8. The information processing system according to claim 5,
wherein when a distance between the assessed value output by the first predicting unit and the reference assessed value output by the third predicting unit is less than a distance threshold value, the attribute influence adjusting unit adjusts the assessed value by a contribution degree of the sensitive attribute information, and outputs the adjusted assessed value.

9. The information processing system according to claim 5,
wherein the second quantizing unit calculates a fourth threshold value on the basis of the estimated value of the sensitive attribute information, the first threshold value for adjusting the assessed value with respect to the preferential attribute, the second threshold value for adjusting the assessed value with respect to the non-preferential attribute, and information relevant to a degree of the sensitive attribute information included in the adjusted assessed value output by the attribute influence adjusting unit, and adjusts the adjusted assessed value output by the attribute influence adjusting unit and outputs the assessment result on the basis of the fourth threshold value.

10. The information processing system according to claim 5, further comprising:
a log management unit which stores the input information, the assessed value output by the first predicting unit, the estimated value of the sensitive attribute information obtained from the second predicting unit, the contribution degree information of each of the input feature amounts, the adjusted assessed value, validity information of a contribution degree of the sensitive attribute information, and the assessment result output by the second quantizing unit as state log information in a storage device, for each event that inputs the input information according to the user and outputs the assessment result; and
a state visualizing unit which reads out the state log information of the past event stored in the log management unit, and calculates a fairness index value to be output to a user screen.

11. The information processing system according to claim 10,
wherein the state visualizing unit displays a transition of an estimated value of the fairness index value with respect to the past event according to the designated sensitive attribute information from the state log information of the past event in a graph, simultaneously displays the state log information of an arbitrary event, and displays an event ID, the assessment result, the contribution degree information of each of the input feature amounts, and the validity information of the contribution degree of the sensitive attribute information as authority description of the assessment result for each of the events in a list to be output to the user screen.

12. An information processing program for allowing a computer to function as:
a first predicting section which outputs an assessed value from input information not including sensitive attribute information that a user has decided not to input;
a second predicting section which has been trained in advance using teacher data to estimate the sensitive attribute information that the user has decided not to input, and estimates the sensitive attribute information from the input information not including the sensitive attribute information; and
a first quantizing section which calculates a third threshold value on the basis of an estimated value of the sensitive attribute information obtained from the second predicting section, a first threshold value for adjusting an assessed value with respect to preferential attribute, and a second threshold value for adjusting an assessed value with respect to non-preferential attribute, and adjusts the assessed value output by the first predicting section and outputs an assessment result on the basis of the third threshold value.

13. An information processing program for allowing a computer to function as:
a first predicting section which outputs an assessed value from input information not including sensitive attribute information that a user has decided not to input;
a second predicting section which has been trained in advance using teacher data to estimate the sensitive attribute information that the user has decided not to input, and estimates the sensitive attribute information from the input information not including the sensitive attribute information;
a third predicting section which inputs the input information not including the sensitive attribute information and the estimated value of the sensitive attribute information output by the second predicting section, and outputs a reference assessed value that has predicted the assessed value output by the first predicting section;
a reference predicting analyzing section which inputs the input information not including the sensitive attribute information and the estimated value of the sensitive attribute information output by the second predicting section, and outputs contribution degree information of each input feature amount with respect to the reference assessed value of the third predicting section;
an attribute influence adjusting section which inputs the assessed value output by the first predicting section, the reference assessed value output by the third predicting section, the contribution degree information of each of the input feature amounts output by the reference predicting analyzing section, and threshold value information, and outputs an adjusted assessed value adjusted to remove an influence of the sensitive attribute information from the assessed value when a distance between the assessed value and the reference assessed value is less than a distance threshold value; and
a second quantizing section which calculates a fourth threshold value on the basis of the estimated value of the sensitive attribute information, a first threshold value for adjusting an assessed value with respect to preferential attribute, a second threshold value for adjusting an assessed value with respect to non-preferential attribute, and information relevant to a degree of the sensitive attribute information included in the adjusted assessed value output by the attribute influence adjusting section, and adjusts the adjusted assessed value output by the attribute influence adjusting section and outputs an assessment result on the basis of the fourth threshold value.
